(19) United States
(12) Patent Application Publication
(10) Pub. No.: US 2021/0327246 A1
(43) Pub. Date: Oct. 21, 2021

(54) SYSTEM AND METHOD FOR DETECTION OF AN ALARM STATE IN A BODY OF WATER

(71) Applicant: SOSENSE LTD., Tel Aviv (IL)

(72) Inventors: Tal SHLOMOVITZ, Tel Aviv (IL); Moshe Harel BEN MOSHE, Modi'in (IL); Aviv FARHI, Bnei-Atarot (IL); Ofer VERFEL, Ein vered (IL); Tal ZURI, Moshav Herut (IL); Josef ROTT, Yuvalim (IL); Asaf Y. FRIEHMANN, Herzelia (IL); Gal BEN DAVID, Tel Aviv (IL)

(21) Appl. No.: 17/347,862

(22) Filed: Jun. 15, 2021

Related U.S. Application Data
(63) Continuation-in-part of application No. 16/769,948, filed on Jun. 4, 2020, now Pat. No. 11,043,229.

(30) Foreign Application Priority Data
Dec. 5, 2017 (IL) 256138

(51) Int. Cl. G08B 21/08; G08B 29/18; H04R 1/44; H04R 1/22; G08B 5/36

(52) U.S. Cl. CPC G08B 21/082; G08B 21/086; G08B 5/36; H04R 1/44; H04R 1/222; G08B 29/185

(57) ABSTRACT

A system and method for the detection of events such as drowning and/or unauthorized entry to a body of water by use of a hydrophone based system and signal processing techniques.

### RELATED APPLICATIONS

This application is a continuation in part of U.S. patent application Ser. No. 16/769,984 filed on Jun. 4, 2020, which is a National Phase Application of PCT Application No. PCT/IL2018/051333 filed on Dec. 5, 2018, which claims priority from IL Patent Application No. 256138 filed on Dec. 5, 2017. This application is also a continuation in part of PCT Application No. PCT/IL2019/051380 filed on Dec. 17, 2019, which claims priority from IL Patent Application No. 263772 filed on Dec. 17, 2018; the entire disclosures of which are herein incorporated by reference in their entireties.

### FIELD OF THE INVENTION

The present invention relates to a system and method for a pool alarm utilized for the detection of unauthorized entry to a body of water, and in particular, to such a system wherein the detection is provided by a processor implemented individualized signal processing techniques of an acoustic signals from within the body of water.

### BACKGROUND OF THE INVENTION

Drowning can occur in any body of water or the like environments such as a pool, lake, sea, ocean and even a bathtub. Drowning does not necessitate that the person does not know how to swim; other factors may come into play that lead to drowning, such as head trauma, orientation loss, disorientation and loss of consciousness.

Children of ages 2-9 are the high risk group for fatal drowning. Daily drowning statistics in the USA show that there are 16 drowning cases of which 120 receive first aid, 40 are hospitalized; 15 recover, 15 suffer irreversible damage and 10 are fatal cases.

One way to combat drowning is preventative devices used by individuals such as floatation devices. Various forms of floatation devices and detections devices exist that function based on individual wearing protective gear such as life vests, floaties, swim rings, variously shaped inflatable floatation devices.

US Patent Publication No. 2013/0328683 to Sitbon et al, teaches a wearable device for drowning detection based on signal processing specific of an individual wearing the device.

U.S. Pat. No. 6,111,510 to Coffelt, discloses a system for underwater drowning detection system that is based on the presence and absence of a sound wave of a bodily function.

Similarly, pool alarms have been used to try to reduce the number of drowning events by detecting when an individual has entered a body of water and/or pool at an unauthorized time, for example, when a lifeguard or the like supervision is not present. However, to date pool alarms have not been able to adequately detect such instances primarily due high rate of false positive where a pool alarm is triggered without just cause.

### SUMMARY OF THE INVENTION

There is an unmet need for, and it would be highly useful to have, system and method capable of identifying unauthorized use of and/or entry into an unattended body of water.

Embodiments of the present invention provide a system and method capable of identifying unauthorized use of and/or entry into an unattended body of water. In some embodiments, the method and system are further capable of identifying and communicating the location of the entry point.

In some embodiments such unauthorized use and/or entry detection is communicated to emergency respondents such as police, firefighters, security guards, medical practitioners, or the like individuals and/or automated devices capable of treating or responding to such emergency events.

Embodiments of the present invention provide for the detection of unauthorized entry into an unattended body of water by utilizing a system configured to monitor a body of water while listening for and detecting an acoustic signal. Preferably when such unauthorized use is detected an alarm state protocol is implemented. The alarm state preferably includes at least one of sounding and alarm, alerting competent individuals for example including but not limited to first respondents, alerting emergency services, the like or any combination thereof.

In embodiments they system further provides for identifying the location and/or point of entry into the body of water.

In embodiments the system comprises an array of hydrophones that are submerged within a body of water that is being monitored. The hydrophone array is functionally linked to a processing device for performing digital signal processing and analysis of the acoustic signal provided by the hydrophone array. In embodiments the signal processing and analysis provides for detecting an acoustic signal indicative of unauthorized entry into a body of water. Embodiments the system may further comprise additional sensors external to the body of water. In embodiments the system may further comprise additional sensor that may be utilized to improve signal to noise ratio. For example, at least one or more microphone(s) may be placed external the body of water to determine background noise. For example, in a pool setting a microphone may be placed near the pool's water-pump and filter providing additional data of the surrounding noise.

In embodiments the system may further comprise additional submersible and/or under water sensors to improve signal to noise ratio from noise emanating from within the body of water being monitored. Such an underwater sensor module may comprise sensors for example including but not limited to movement sensor, accelerometer, gyro sensor, depth sensor, pressure sensor, temperature sensor, pH sensor, camera, optical sensor, the like, or any combination thereof configured to be submersible within the monitored body of water.

In embodiments the system may further be in communication with or functionally associated with at least one or more auxiliary devices for communicating an alarm state and/or sounding an alarm state. An auxiliary device may for example include but is not limited to a horn, an alarm, a communication device, a mobile communication device, a server, a first respondent call center, emergency services call center, the like or any combination thereof.

The system and method of the present invention preferably provides a safety measure against unauthorized entry into a body of water such as a pool, lake, ocean or the like body of water. In some embodiments the system may further provide a safety measure against accidental drowning within the body of water.

In embodiments of the present invention provides a system and method that both identifies unauthorized entry into a body of water and drowning incidents within the body of water. In embodiments the hydrophone array comprising a plurality of hydrophones may be distributed and/or arranged within the monitored body of water in any manner so as to provide sufficient coverage of the entire area of the body of water. For example, the hydrophone array may be arranged in a grid arrangement, a concentric arrangement, a triangulation arrangement, single layer arrangement, multi-layered (depth) arrangement, the like or any combination thereof.

In some embodiments the hydrophone array may be arranged in a planar grid-like manner along a lower surface of the body of water, for example a swimming pool.

In some embodiments the hydrophone array may be arranged in multilayer arrangement wherein hydrophones are placed along a lower surface and along at least one or more side (wall) surface. For example, a first hydrophone array arrangement along the bottom surface of a pool and a second hydrophone array arrangement along the height of at least one or more walls of a pool.

In embodiments the hydrophones may be placed at a distance (d) from the walls and/or edges of a pool defining the body of water being monitored. In embodiments, distance (d) may be configured so as to ensure the quality of the acoustic signal being monitored so as to reduce and/or circumvent any echo and/or reflection effect that may arise by placement of hydrophone along the edge of the body of water for example a pool wall.

In embodiments placement of each hydrophone is preferably provided with a unique location specific address for example a GPS address and/or coordinates. Preferably the unique hydrophone address is provided to facilitate identification and localization of the source of the unauthorized entry and/or drowning event within the body of water. In some embodiments, the unique hydrophone address may further provide for communicating the location of a drowning victim within the body of water. Optionally location is communicated to an auxiliary device and/or system as previously described and identifiable on a map.

In embodiments, individual hydrophones forming the hydrophone array may be further associated with a local sensor and/or transducer, for example including but not limited to a pH sensor and/or a temperature sensor, a light source, accelerometer, the like or any combination thereof. More preferably individual hydrophones may be associated with and/or adjacent to a temperature sensor to determine the ambient water temperature. In some embodiments a selective portion of the hydrophones array will be fit and/or functionally associated with a temperature sensor.

In embodiments the hydrophone array may be formed from a plurality of individual hydrophones that are functionally coupled with the processing center and/or device in a wired or wireless manner. Accordingly, the hydrophones may be wireless and/or wired hydrophones that are functionally coupled and operational with the processing center and/or device.

In embodiments the processing center may provide for implementing a proprietary processor mediated signal processing method of the acoustic signals received from the hydrophone array in order to monitor, detect and locate a drowning incident within a body of water.

In embodiments the processing center may provide for implementing a proprietary signal processing method of the acoustic signals received from the hydrophone array and/or surface microphones in order to monitor, detect unauthorized entry into the body of water. In embodiments, the processing center may further provide for identifying the location of the unauthorized entry.

In embodiments the processor mediated signal processing method comprises performing filtering and analysis in the frequency domain to identify a unique acoustic signature indicative of a drowning individual. The acoustic signature is identifiable and within a specific frequency band from about 200 Hz up to about 1200 Hz.

In embodiments, the processing center preferably comprises and/or is functionally associated with an acoustic signature bank and/or library and/or database of a pre-classified drowning acoustic signature signals that will preferably facilitate the process of the identification and analysis of the acoustic signals obtained from the hydrophone array.

Most preferably the acoustic signature is associated with acoustic waves generated by a drowning individual during a drowning event. The drowning sound may be explained on the basis of known anatomical defense reflexes that together are implemented to try to prevent entry of water or unwanted substance into the upper and lower respiratory system. These reflexes include a laryngospasm and a cough reflex that are known to be activated by irritant receptors that are located mainly on the wall of the trachea, pharynx, and carina, or by stimulation of the auricular branch (Arnold's reflex via internal laryngeal nerve). When both reflexes are triggered, axonal impulses of the vagus nerve begin a chain reaction that reaches the medulla, with efferent back into respiratory system (glottis, vocal cords, diaphragm, intercostal muscles) is observed. A combination of these reflexes activate a blocking and/or repelling defensive actions to prevent water, or the like foreign object, from entering the respiratory system, and in turn gives rise to the unique drowning acoustic signature, monitored by the system and method defining embodiments of the present invention.

In embodiments, the processing center provides for identifying the location of the drowning incident by processing digital data received from the hydrophone array by utilizing a phase control processing techniques to generate a directional beam emanating from select hydrophones so as to determine and map the location of the drowning incident relative to the hydrophone array placement.

Within the context of this application the term hydrophone refers to an underwater microphone adept at obtaining acoustic signals under water. Any form of a hydrophone as is known in the art may be utilized.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention.

Section headings are used herein to ease understanding of the specification and should not be construed as necessarily limiting.

Unless otherwise defined the various embodiment of the present invention may be provided to an end user in a plurality of formats, platforms, and may be outputted to at least one of a computer readable memory, a computer display device, and a printout, a computer on a network or a user.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

It should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, or the like. Any two or more of such devices in communication with each other, and/or any computer in communication with any other computer may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-B are schematic block diagrams of a system for the detection of unauthorized entry and/or drowning into a body of water according to embodiments of the present invention; and

FIG. 2A is a schematic flow chart showing a method for identifying and/or detection unauthorized entry into a body of water with the system according to the present invention;

FIG. 2B is a schematic flow charts showing a method for identifying and/or detecting a drowning incident with the system according to the present invention;

FIG. 3 is a schematic flow chart showing a method for identifying and/or detecting unauthorized entry into a body of water with the system according to the present invention;

FIG. 4 is a schematic block diagram of a system and method implementation for drowning detections according to an embodiment of the present invention;

FIG. 5 is a schematic illustration of a swimming pool fit with the system for according to an embodiment of the present invention; and

FIG. 6A-B are schematic graphical illustrations of an acoustic signal obtained with the system according to an embodiment of the present invention;

FIG. 6A shows filtered raw signals, in the time domain, obtained from the hydrophone module; FIG. 6B shows the signal in the frequency domain following signal processing that identifies a drowning acoustic signature in the range between 200 Hz and 1200 Hz.

### DESCRIPTION OF THE PREFERRED EMBODIMENTS

The principles and operation of the present invention may be better understood with reference to the drawings and the accompanying description.

The following figure reference labels are used throughout the description to refer to similarly functioning components are used throughout the specification hereinbelow.
10 monitored body of water;
12 pool systems;
20 auxiliary device(s);
100 monitoring system;
101 hydrophone module;
102 hydrophone array;
103 accelerometer;
104 processing center;
105 alarm signal;
106 external environmental sensor;
107 alarm module;
108 in-water auxiliary sensor module;
109 housing;
110 signal processing module;
112 adaptive filter;
114 frame splitter;
116 frequency analysis;
118 signature library;
120 beam forming phase control module;
122 decision logic module;
124 alarm state module;
130 electronics/circuitry module;
132 microprocessor sub-module;
134 power sub-module;
136 communication sub-module;
138 memory sub-module;
150 individualization module;

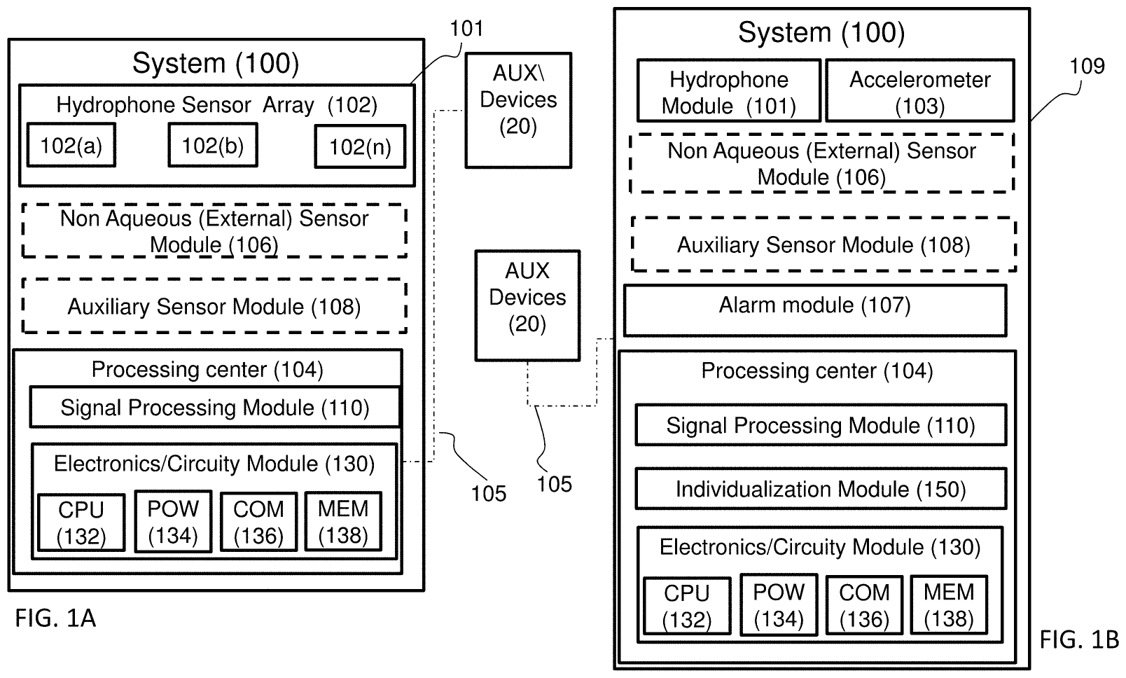

Referring now to the drawings, FIG. 1A-B show a schematic block diagram of system 100, according to embodiments of the present invention. System 100 provides a pool alarm system that provides for monitoring a body of water so as to detect acoustic signals associated with at least one event selected from a drowning event and/or unauthorized entry. Monitoring of the body of water and the detection with the acoustic signal is provided by implementing a processor mediated signal processing method for detecting at least one of a drowning event and/or unauthorized entry into a body of water. The body of water may be a pool, spa, Jacuzzi, designated areas and/or portions and/or segments of a natural body of water such as a lake, river, sea, and/or ocean.

System 100 comprises a hydrophone module 101 comprising at least one hydrophone for capturing acoustic signals and a processing center 104 for implementing signal processing of the acoustic signals captured with the hydrophone module 101.

Hydrophone module 101 comprising at least one hydrophone. In some embodiments hydrophone module 101 may be provided in the form of a hydrophone array 102 including a plurality of hydrophones (102_{a . . . n}) including ‘n’ hydrophones where ‘n’ is at least four (n>4). The hydrophone module 101 and/or hydrophone array 102 is submerged in the body of water being monitored, while the processing center 104 provides for signal processing of the acoustic signals provided by the hydrophone module 101 and/or hydrophone array 102 preferably so as to enable detection of at least one event associated with the body of water for example including but not limited to a drowning event and/or unauthorized entry of the body of water when it is not supervised and/or guarded. In embodiments system 100 may further feature an alarm module 107 provided for rendering an alarm state when an event is detected for example including but not limited to a drowning event and/or unauthorized entry.

In some embodiments system 100 may further comprise an additional sensor in the form of an accelerometer 103.

Accordingly in embodiment of system 100 hydrophone module 101 provides for obtaining sound from within the body of water so as to detect events within the water, for example including but not limited to at least one of drowning event and/or when unauthorized entry is detected. According to additional embodiments of system 100 an accelerometer 103 may be provided for detecting the water surface movement levels. In embodiments accelerometer 103 in combination with hydrophone 101 provides a system 100 capable of detecting generated sound from within the body of water while accelerometer 103 provides for detection movement of the water surface in such a manner system 100 provides a multilayer detection system so as to improve the identification of a potential alarm state, for example including a drowning event and/or unauthorized entry.

In embodiments, hydrophone module 101 may be take any form, and may be distributed and/or arranged within the monitored body of water in any manner so as to provide sufficient coverage of the entire area of the body of water. In some embodiments hydrophone 101 may be placed at a depth of at least 10 cm below the surface. In some embodiments hydrophone 101 may be placed at a distance of 10 cm away from an edge of a body of water for example a pool wall.

In embodiments alarm module 107 preferably provides a speaker and/or horn that is wirelessly associated and/or coupled hardwired with system 100. For example, alarm module 107 provides for sounding an alarm when an alarm state is identified by processing center 104. In embodiments processing center 104 preferably produces an alarm signal 105 that is communicated to alarm module 107 so as to sound an alarm that is either wirelessly coupled and/or hardwired with system 100.

In some embodiments, system 100 may further comprise at least one or more optional sensor(s) in addition to the hydrophone 101 and accelerometer 103, for example as part of a non-aqueous sensor module 106 and/or an aqueous (in-water) sensor module 108.

In embodiments sensor module 106 provides for improving and/or facilitating detection an alarm state for example including but not limited to a drowning event and/or unauthorized use of a body of water. Sensor module 106 may for example include at least one or more optional sensors for example including but not limited to microphone, video cameras, thermal imaging device, infrared (IR) devices, LIDAR, a video surveillance system, an image capturing device, the like or any combination thereof, Sensor module 106 may for example comprise at least one or more microphone that is placed external the body of water and may be utilized to facilitate and/or improve detection of unauthorized pool entry and/or drowning incident.

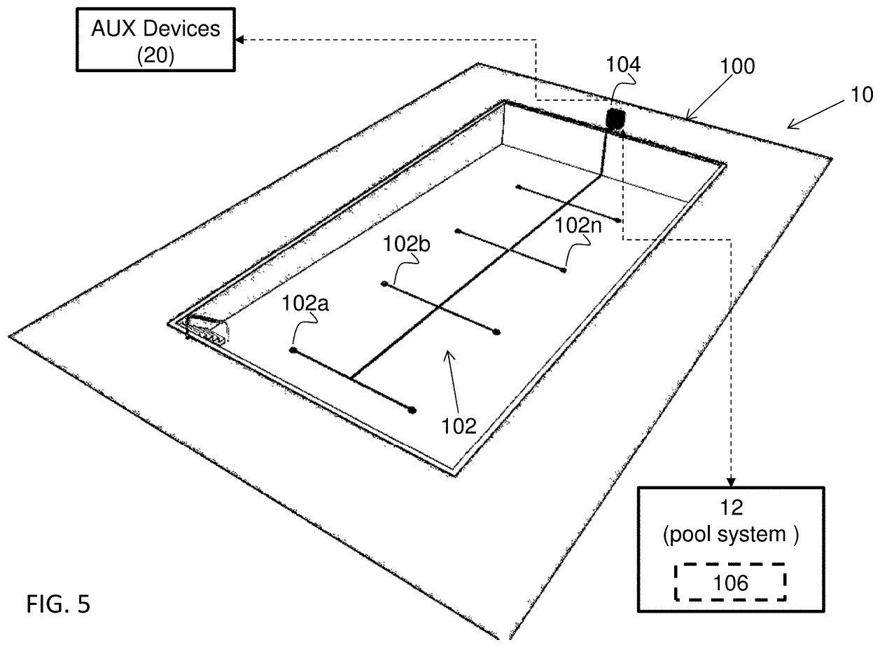

For example, in an optional system 100 that is utilized in a pool setting (FIG. 5), sensor module 106 may comprise a microphone that may be placed adjacent to the pool's machine room to pick up acoustic signal emanating from the pool's water-pumps and filters provided so as to identify their contribution to noise and/or acoustic signals sensed by the hydrophone module 101 within the body of water. Such data may be utilized by system 100 to improve signal to noise ratio by provide additional data of potential environmental noise in and around the body of water. A further example, an external microphone may be placed to monitor above ground sounds in the perimeter of the body of water, for example a swimming pool, to improve signal to noise ratio where noise generated above the water surface may be removed and/or accounted for when monitoring and/or listing for an in water drowning acoustic signature signal. For example, noise generated by kids splashing and playing above the water surface that is received and/or picked up by the hydrophone module 101 and/or hydrophone array 102 and thereafter may be filtered out and/or accounted for and/or recognized as noise, so as to improve signal to noise ratio of the hydrophone signal.

In some embodiments system 100 may be further fit with an auxiliary in-water sensor module 108, including at least one or more submerged and/or underwater sensors and/or transducer to facilitate and/or improve the acoustic signal. Such additional submersible and/or under water sensors may be provided to improve signal to noise ratio from noise emanating from within the body of water being monitored. Such an underwater sensor module may comprise sensors for example including but not limited to additional hydrophones, hydrophones associated with a pool automated cleaning robot, depth sensor, pressure sensor, temperature sensor, pH sensor, camera, optical sensor, light the like, or any combination thereof configured to be submersible within the monitored body of water.

In some embodiments system 100 may be provided in a dedicated housing 109 that may be provided in the form of a floating housing having a water surface portion featuring accelerometer 103 and/or portion of electronics circuitry 130 and a submerged portion including hydrophone 101 comprising at least one hydrophone.

In some embodiments system 100 may be provided in a housing 109 that may be provided in the form of a floating housing having a submerged portion including at least one hydrophone 101. Optionally hydrophone 101 may be disposed at least 10 cm below the water surface.

In some embodiments system 100 may be provided in a housing 109 that may be provided in the form of a tethered and/or stationary housing that is disposed at a predefined location within the body of water and relative to at least one surface, for example a pool sidewall and/or floor (lower surface). Optionally hydrophone 101 may be disposed at least 10 cm below the water surface and at a distance of 10 cm away from a hard surface such as a pool sidewall and/or floor.

In some embodiments housing 109 may be integrated with optional auxiliary devices 20 forming a portion of a pool system for example including but not limited to pool control system, pool valves, water feature subsystem (e.g., waterfall), pool lighting system, pool sanitation system, pool cleaning robot, pool temperature control systems, pool pump system, pool sound system, pool filtration system, or the like pool system.

In embodiments system 100 includes a processing center 104 having processing and communication capabilities that provides for undertaking the communication and signal processing required to identify and trigger an alarm state when a drowning incident and/or unauthorized use of a body of water is identified based on the signal(s) captured from the hydrophone 101 associated with device 100. In some embodiments processing center 104 provides for analyzing signals provided from both hydrophone 101 and accelerometer 103.

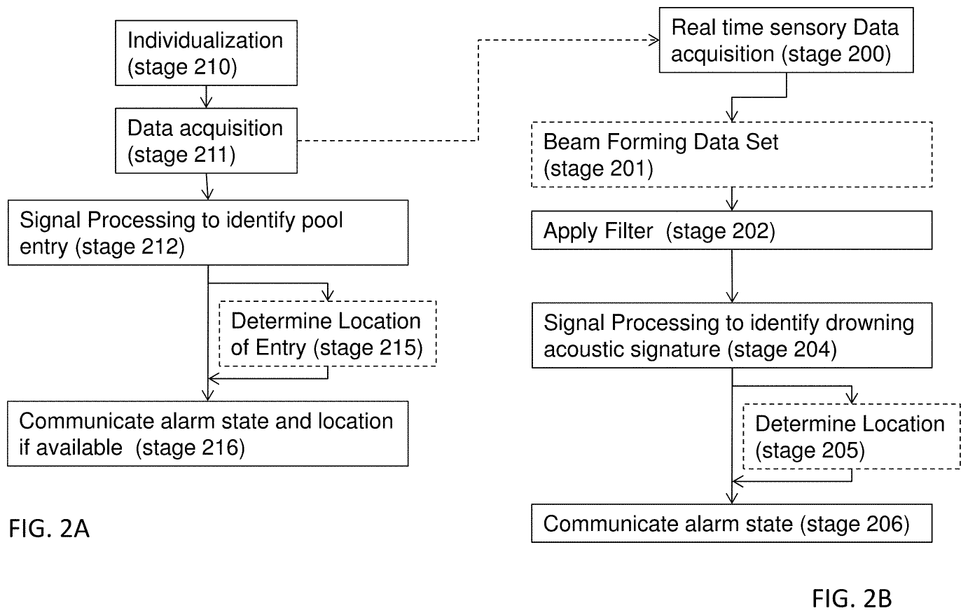

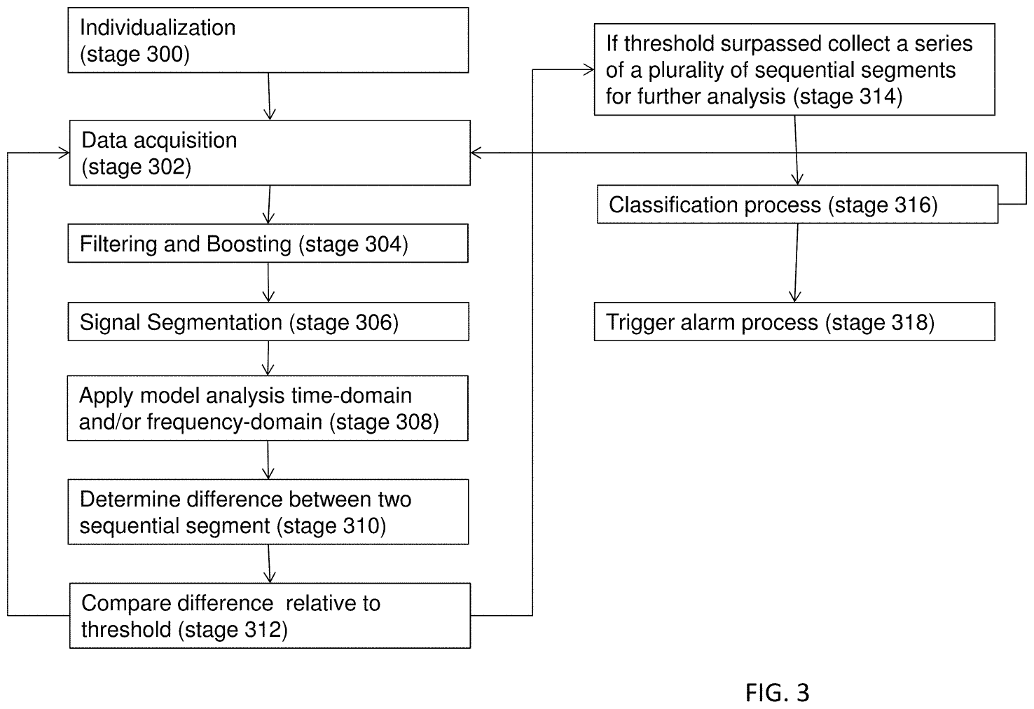

Processing center 104 implements a processor mediated method for identifying the acoustic signal associated with unauthorized entry into the body of water, as will be described in greater details with respect to FIG. 2A-B and FIG. 3.

In embodiments processing center 104 may be disposed within the body of water or external to the body of water being monitored. In some embodiments processing center may be formed from a plurality of sub-modules wherein some sub-modules are within the body of water and some sub-modules are external to the body of water.

In embodiments processing center 104 may be functionally associated with the hydrophone module 101, 102 in a wired or wireless manner. Accordingly, the hydrophone module 101 may comprise a wireless hydrophone and/or wired hydrophone that are functionally coupled and operational with the processing center 104 of system 100.

Processing center 104 comprises a signal processing module 110 and an electronics/circuitry module 130 that provide for identifying an acoustic signal within the body of water and implementing an alarm procedure and/or state once at least one event selected from unauthorized entry and/or drowning is identified so as to generate an alarm and/or to communicate an alarm signal 105.

Signal processing module 110 preferably provides for implementing a processor mediated method for identifying and classifying the acoustic signal provided by hydrophone module 101 so as to identify at least one of an incident of unauthorized entry into the body of water and/or an accidental drowning event.

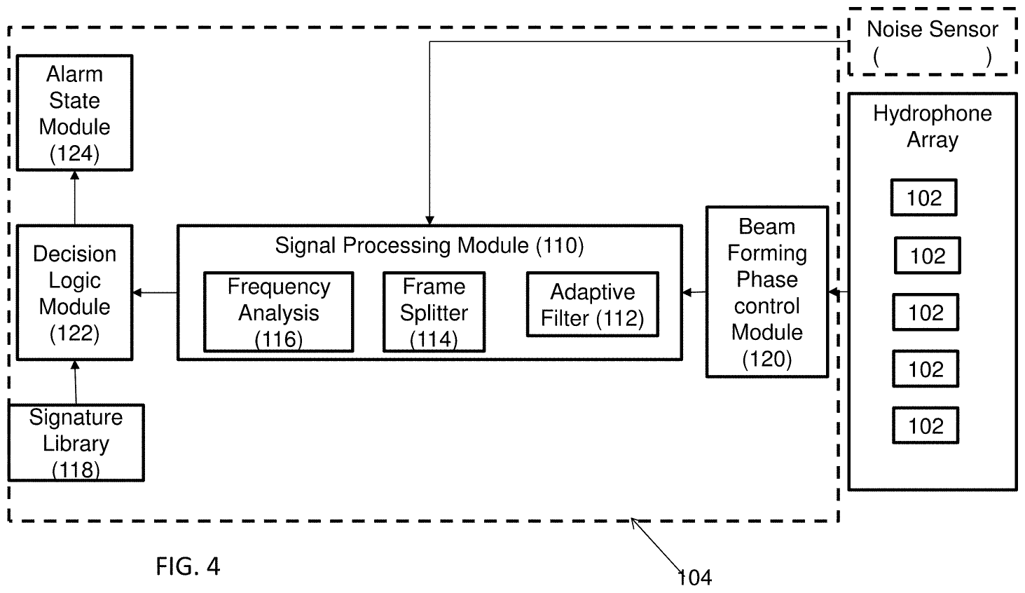

The methods implemented by processing module 110 in order to identify an alarm state wherein a foreign body and/or object has entered the body of water monitored with system 100 is described in greater detail in FIG. 2A and FIG. 3, while FIG. 2B and FIG. 4 describes the role of module 110 in detection of drowning incident. Signal processing module 110 provides for analyzing and identifying an alarm state that is identified with at least one hydrophone provided with hydrophone module 101 and/or optionally from data provided by both hydrophone 101 and accelerometer 103. Hydrophone 101 provides acoustic signals and/or data obtained from within the body of water that are analyzed. Optional accelerometer may provide data from the water surface of the body of water.

Processing module 110 provides for analyzing at least one of an acoustic signal obtained with hydrophone module 101. In some embodiments processing module may further provide for processing additional data obtained with accelerometer 103 so as to determine if a foreign body and/or object has entered the body of water being monitored.

In some embodiments module 110 provides for processing acoustic signal received with hydrophone module 101 by implementing digital signal processing techniques that include filtering the signal, boosting the signal, segmenting the signal into a plurality of overlapping segments, applying model analysis of the segments in at least one and/or both of time-domain and frequency-domain, so as to determine a difference in the signal when comparing two consecutive signals relative to a threshold level so as to identify a potential alarm state, and thereafter classification of the potential alarm state.

In embodiments the time-domain model utilized is preferably an auto-regressive (AR) model analysis.

In embodiments the frequency domain model utilized a Mel Frequency Cepstrum Model (MFCM).

In embodiments processing module 110 may utilize both auto-regressive (AR) model analysis and Mel Frequency Cepstrum Model (MFCM) in order to analyze a particular acoustic signal.

In embodiments classification stage may be provided by a deep learning system that is configured to identify events by comparison to known and/or learnt and/or historic events.

In embodiments processing module 110 may be associated with an individualization module 150, shown in FIG. 1B, that is utilized to individualize processing module 110 relative to a particular body of water that is being monitored, for example including but not limited a pool. Accordingly, individualization module 150 provides for determine and/or fine tuning the specific coefficients utilized for the various stages of the processing module 110, accordingly determining at least one or more selected from: the filtering coefficients, the boosting filter coefficient; time-domain model analysis coefficient, frequency-domain model analysis coefficient, AR model coefficients, Cepstrum (MFCM) model coefficients, classification weights and/or coefficients, and any combination thereof.

In embodiments, system 100 defines a system and method that provides for individualized pool alarm that is configured specifically for the body of water and/or pool configuration so as to improve sensing of a true alarm state, for example including but not limited to unauthorized entry and/or drowning event.

In embodiments the individualization module 150 may require a period of time to ascertain and/or determine the individualize properties of the body of water being monitored to be utilized with and maximize the robustness and performance of processing module 110. In embodiments module 150 may be implemented with a learning algorithm and/or via experimental data.

In some embodiments, placement of each hydrophone utilized as part of hydrophone module 101 may be provided with a unique, location specific address, for example a GPS address and/or geographical coordinates. Preferably such a unique hydrophone address is provided to facilitate communicating the location of the hydrophone that is associated with the alarm state, for example drowning incident and/or unauthorized entry. Preferably such an address is utilized so as to indicate proximity of the hydrophone to the location of the alarm state. Optionally location may be communicated to an auxiliary device and/or system 20 and may be identifiable on a map.

Electronics/circuitry module 130 preferably provides the hardware and/or software necessary to implement the processing and communication necessary to monitor the body of water to identify an acoustic signal indicative of at least one alarm state and/or event selected from unauthorized entry and/or drowning incident.

Electronics/circuitry module 130 comprises a microprocessor sub-module 132, a power sub-module 134, a communication sub-module 136, a memory sub-module 138, the like or any combination thereof.

In embodiments processor sub-module 132 provides the necessary processing hardware and/or software necessary to render processing center 104 functional and/or to render system 100 functional.

In embodiments power sub-module 134 provides the necessary hardware and/or software to power processing center 104 and/or system 100.

In embodiments communication sub-module 136 provides the necessary hardware and/or software to facilitate communication for system 100 with optional auxiliary device(s) 20 and/or the hydrophone module 101,102.

In embodiments memory sub-module 138 provides the necessary memory and/or storage hardware and/or software to facilitate operations of system 100 and/or processing center 104.

In embodiments system 100 may be in communication with and/or functionally associated with at least one or more auxiliary devices 20. Auxiliary device 20 may be utilized to receive an alarm signal 105 indicative of an alarm state and/or sounding an alarm state.

In some embodiments system 100 may be integrated with optional auxiliary device(s) 20 for rendering a pool alarm system.

An auxiliary device 20 may for example include but is not limited to a horn, an alarm, a video surveillance system, a camera, an image capturing device, a pool system device, a thermal imaging sensor, thermal imaging device, an infrared device, a Light Detection And Ranging (LIDAR) sensor, a communication device, a mobile communication device, a server, a first respondent call center, emergency services call center, pool associated systems, the like or any combination thereof. In some embodiments auxiliary device 20 may for example be realized in the form of a mobile communication device such as a smartphone, may be fit with necessary software and/or dedicated application (app) to receive an alarm state signal 105.

In some embodiments auxiliary device 20 may for example be realized in the form of a video and/or image surveillance system provided for image capture and/or analysis of the pool area.

In some embodiments auxiliary device 20 may for example be realized in the form of pool associated systems for example including but not limited to pool control system, pool valves, water feature subsystem (e.g., waterfall), pool lighting system, pool sanitation system, pool cleaning robot, pool temperature control systems, pool pump system, pool sound system, pool filtration system, or the like pool system.

In embodiments LIDAR or the like IR sensor may be utilized to confirm and/or determine if a body has entered a body of water by providing a proximity sensor. For example, if processing center 104 indicates that an object has entered the body of water a LIDAR and/or the like IR sensor may be utilized to determine and confirm that a foreign body is at a given distance from system 100.

In embodiments a thermal imaging device and/or sensor may be utilized to facilitate identification of a foreign body within the body of water. For example, if processing center 104 indicates that a foreign body and/or object has entered the body of water a thermal imaging device and/or sensor may be utilized to determine and confirm that a foreign body is within the body of water based on thermal imaging. Similarly, a camera and/or the like imaging device may be utilized to corroborate any alarm signal identified by processing center 104 so as to visualize any such foreign body. Accordingly, such additional auxiliary sensors and/or devices may be used to either corroborate and/or identify a false positive alarm state identified by processing center 104.

FIG. 1A shows an optional embodiment of system 100 wherein hydrophone module 101 is provided in the optional form of a hydrophone array 102 including a plurality of individual hydrophones (102_{a . . . n}) including ‘n’ hydrophones where ‘n’ is at least two (n>1) that are submerged in the body of water being monitored, and a processing center 104 that provides for signal processing of the acoustic signals provided by the hydrophone array 102 so as to detect unauthorized entry and/or a drowning event.

In embodiments the hydrophone array 102 may be take any form, where the plurality of hydrophones may be distributed and/or arranged within the monitored body of water in any manner so as to provide sufficient coverage of the entire area of the body of water.

In some embodiments the hydrophone array 102 may be formed from a plurality of sub-arrays that are associated with processing center 104. For example, to cover a large body of water a plurality of sub-arrays may be utilized with a single processing center 104.

For example, the hydrophone array 102 may be arranged in a grid arrangement, a concentric arrangement, a triangulation arrangement, single layer arrangement, multi-layered (depth) arrangement, the like or any combination thereof.

In some embodiments the hydrophone array 102 may be arranged in a planar grid-like manner along a lower surface of the body of water, for example a swimming pool.

In some embodiments the hydrophone array 102 may be arranged in a planar grid-like manner along a lower surface of the body of water, for example a swimming pool and/or adjacent to a lower surface of the body of water, for example a swimming pool. For example, in a non-limiting embodiment array 102 may be disposed along the swimming pool floor. For example, in a non-limiting embodiment array 102 may be disposed adjacent to a swimming pool floor and/or wall wherein individual hydrophones forming array 102 may be placed at a distance (d) above the swimming pool floor itself such that the hydrophones are suspended near the floor but not on the floor itself. In some embodiments distance (d) may be in the order of a few centimeters for example up to about 15 cm from the swimming pool floor.

In some embodiments the hydrophone array may be arranged in multilayer arrangement wherein hydrophones are placed along a lower surface and along at least one or more side (wall) surface. For example, a first hydrophone array arrangement may be placed along the bottom surface of a pool and a second hydrophone array arrangement along the height of at least one or more walls of a pool.

For example, a hydrophone array 102 disposed within a swimming pool may comprise at least four hydrophones 102n, that are organized in a grid-like manner, and distributed in two rows, wherein each row is disposed on the pool's floor and/or near the pool's wall, that is along opposite junctions of the pool's long edge. A first row disposed adjacent to the bottom of the left pool wall and a second row of hydrophones disposed opposite the first row and placed adjacent to the bottom of the right pool wall.

In embodiments the number of individual hydrophones 102n may be a function of the pool's dimensions. For example, a hydrophone may be placed at set intervals of about 1 meter and up to about 3 meters along a pool's length.

In embodiments a hydrophone array and/or sub-array may be imbedded in a flexible platform and/or housing that maintains the arrangement of the individual hydrophone forming the array and/or sub-array. For example, such a housing and/or flexible platform may be a vinyl surface that is embedded with individual hydrophones and submerged within the body of water being monitored.

In embodiments, the flexible platform and/or may be functionally coupled with processing center 104 by wiring or wireless communication.

In embodiments, the housing and/or platform of the hydrophone array 102 and/or sub-array may further comprise a local electronics and circuitry module comprising a power source sub-module, processor sub-module, memory sub-module, and communication sub-module, and wherein the local electronics and circuitry module is functionally coupled with the processing center 104 by way of a wireless communication protocol and/or hard wiring.

In embodiments the platform and/or housing may be a flexible water impermeable material, for example including but not limited to vinyl.

In embodiments, individual hydrophones (102n) forming the hydrophone array 102 may be further associated with a local sensor and/or transducer, for example including but not limited to a light source, a pH sensor, a temperature sensor, and/or an accelerometer, the like or any combination thereof.

In embodiments individual hydrophones (102n) may be fit with a temperature sensor to determine the temperature in and around the individual hydrophone (102n) and the hydrophone array (102). In particular, such a temperature sensor could facilitate signal processing of the sound recorded with the hydrophones.

In embodiments individual hydrophones (102n) may be fit with an accelerometer to aid in signal processing, and in particular to improve on signal to noise ratio of the acoustic signal provided by array 102 and/or individual hydrophones 102n.

In embodiments individual hydrophones 102n may be fit with and or disposed adjacent to a light source, for example a Light Emitting Diode (LED). In embodiments, the LED adjacent to a hydrophone 102n may be a multi-color (RGB) LED. In embodiments system 100 may be configured to activate the light source selectively only if a drowning incident is sensed. In embodiments, only the lights adjacent to the location of the drowning event are activated so as to readily identify the location of the drowning incident.

In embodiments, the wavelength of the light source may be selected and/or lit according to its proximity to the drowning event, therein acting to facilitate as a locating and/or honing signal to identify the location of the drowning event, in particular such is advantageous at night or dark environment. For example, light closest to the drowning event/location may be selectively lit as Red while those light that are further away from the drowning event/location may be lit as Blue.

FIG. 2A shows a flow chart of a method for identifying unauthorized entry into a body of water by way of detecting and identifying an acoustic signal in a body of water, for example a swimming pool, that is fit with and monitored with system 100.

First in stage 210 the body of water being monitored undergoes individualization so as to determine the optimal signal processing coefficients to be utilized with processing module 110 as previously described. Preferably during individualization processing module 110 of system 100 is individualized relative to the body of water so that the signal processing is optimized for detection. During individualization, provided with module 150, preferably at least one or more of the signal processing coefficients such as: the filtering coefficients, the boosting filter coefficient; time-domain model analysis coefficient, frequency-domain model analysis coefficient, AR model coefficients, Cepstrum (MFCM) model coefficients, classification weights and/or coefficients, and any combination thereof, are determined and finalized so as to optimize the performance of system 100.

Next in stage 211 following individualization, real time acoustic signals are received and/or acquired from system 100 via hydrophone module 101 or hydrophone array 102. The data is communicated to and delivered to processing center 104 for processing substantially in real time.

In some embodiments data acquisition may be utilized in parallel both for unauthorized entry detection (FIG. 2A) and/or drowning detection (FIG. 2B).

Next in stage 212, processing center 104 and more preferably signal processing module 110 undertakes signal processing techniques to identify unauthorized entry into a body of water. Signal processing techniques are implemented on the clean signal to identify the acoustic signal associated with unauthorized entry or the like alarm state so as to generate an alarm signal 105. Preferably such signal processing techniques comprise filtering, frame splitting, time-domain analysis, frequency domain analysis, artificial intelligence decision support analysis, or the like as discussed above.

In an optional stage 215, if an acoustic signal associated with unauthorized entry is identified, the processing module may be further configured to identify the location of the entry point into the body of water. Optionally such location identification may be provided with the aid of additional sensors for example including but not limited to a network of hydrophones, imaging sensor, video analysis, an IR sensor, LIDAR sensor, thermal imaging sensor, the like or any combination thereof.

In optional embodiments, determining the location of the unauthorized entry may comprise, during installation, providing individual hydrophones with an address in the form of a geographical coordinates (GPS coordinates). Next determine from the acoustic data which of the hydrophones are involved in generating the acoustic signal. Finally, cross reference the hydrophones involved in generating the acoustic signal for unauthorized entry with the hydrophone's geographical coordinate address to define the point of entry.

Next in stage 216, an alarm state signal 105 is communicated to at least one or more auxiliary device(s) 20 associated with system 100, to undertake an alarm state protocol. Optionally an alarm state signal 105 may further comprise location of the unauthorized entry event based on location identified in optional stage 215. Preferably the location is provided in the form of geographical coordinates.

FIG. 2B shows a flow chart of a method for identifying an alarm state in the form of a drowning event by way of identifying a drowning acoustic signature signal from within a body of water, for example a swimming pool, that is fit with and monitored with system 100 according to the present invention.

First in stage 200, similar to state 211 described above with respect to FIG. 2A, real time acoustic signals are received from system 100 via the hydrophone array 102 disposed within the body of water being monitored. The acoustic data is communicated to and delivered to processing center 104 for processing substantially in real time.

Next in an optional stage 201, the raw data obtained undergoes beam forming via a phase control module 120, described in FIG. 4, where each hydrophone 102n comprising the hydrophone array 102 is utilized to form a plurality of directional acoustic beams in a manner that will cover the area defined by the hydrophone array 102 and the volume of the body of water being monitored. Preferably beam forming facilitates locating the drowning event as will be described below in optional stage 205. In embodiments the phase control module 120 will apply variable phase control shifts to individual hydrophones (102n) of the hydrophone array 102 so as to cover the entire monitored body of water.

Next in stage 202, processing center 104 and more preferably signal processing module 110 applies noise reduction filtering so as to clean the hydrophone acoustic signal allowing further processing of the signal. Preferably the filter applied may be applied directly to the data provided by array 102 as well as additional environmental data provided from external sensor module 106. Filtering may for example include adaptive filtering or the like filtering as is known in the art.

Next in stage 204, further signal processing techniques are implemented on the clean signal to identify the drowning acoustic signal within the body of water and an alarm signal 105 is generated. Preferably such signal processing techniques comprise filtering, frame splitting, frequency domain analysis, artificial intelligence decision support analysis, signal decimation, down sampling, up sampling, interpolation, determination of minimum and/or maximums, identifying harmonics, wavelet analysis, power analysis, signal differentiation, signal compression, signal decompression, transformations, regression analysis, or the like as is known in the art.

Next in optional stage 205, if a drowning acoustic signature signal is identified, the processing module further identifies the location of the individual hydrophones (102n) that generated and/or picked up and/or are involved in the identification of the drowning signature signal, so as to identify the location of the suspect drowning event. Optionally and preferably during an alarm state preferably the drowning incident location is identified and communicated.

In embodiments, determining the location of the suspect drowning event may comprise: providing individual hydrophones (102n) with an address in the form of a geographical coordinates (GPS coordinates), preferably an address is provided during installation of system 100; next determine from the acoustic data which of the hydrophones are involved in generating the acoustic drowning signature signal; finally, cross reference the hydrophones involved in generating the signature signal with the hydrophone's geographical coordinate address to define area of drowning event.

Next in stage 206, alarm state signal 105 is communicated to at least one or more auxiliary device 20 associated with system 100, to undertake an alarm state protocol. Optionally and preferably an alarm state signal 105 may further comprise the location of the drowning event based on location identified in optional stage 205. Preferably the location is provided in the form of geographical coordinates.

Now referring to FIG. 3 showing a details depiction of the signal processing technique utilized to identify an alarm state in the form of unauthorized entry, as previously described in FIG. 2A.

First in stage 300 individualization stage is undertaken and performed with individualization module 150 so as to ensure that the signal processing module 110 is properly configured for the specific body of water.

Next in stage 302 data acquisition is obtained with at least one or more sensor including at least one hydrophone of hydrophone module 101 and optionally with an accelerometer 103.

Next in stage 304 filtering and boosting is performed so as to obtain a clean and optimized signal on which further signal processing is performed. Preferably the filters utilized are individualized filters based on filter coefficients obtained in stage 300.

Next in stage 306 the filtered signal is segmented into a plurality of overlapping segments. Optionally the length of the segments may be individualized according to stage 300. Optionally the segments may be further overlapping. Optionally the degree of overlap may be determined during the individualization stage 300 as previously described.

Next in stage 308 at least one and/or both of a time-domain and/or frequency domain modelling analysis is undertaken on each individual segments.

Next in stage 310 a comparison of two sequential segments is performed so as to identify any changes between the two, a change indicative of an event, and a potential alarm state event.

Next in stage 312 thresholding is performed so as to compare the different between the two segments relative to a predetermined threshold level. Optionally the threshold level may be an individualized threshold determined during stage 300. If threshold is not surpassed continue to monitor and revert to stage 302.

Next in stage 314 if the threshold is crossed (stage 312) a series of a plurality of sequential segments is obtained for further analysis and classification.

Next in stage 316 the signal provided in stage 314 is classified further to determine if an alarm state has indeed occurred or if it has not. If an alarm state is determined, an alarm state signal is trigged in stage 318. If an alarm state is not identified monitoring is continued as is described in stage 302. As previously described in stage 316 determination of the alarm state may be provided and/or facilitated with additional sensors for example including but not limited to at least one or more of: imaging device, thermal imaging, IR sensors and/or a plurality of hydrophones.

In stage 318 if an alarm state is triggered alarm module 107 provides for sounding an alarm and/or sounding a silent alarm and/or contacting relevant individuals, for example including but not limited to first respondents police department, fire department, security guards, ambulatory care the like or any combination thereof.

FIG. 5 shows a schematic illustration of system 100 as implemented in an in-ground swimming pool 10 setting. As seen hydrophone array 102 comprises a plurality of individually hydrophones 102a, 102b, 102n is disposed along a lower surface of the pool, forming a grid-like coverage of the pool floor. Array 102 is functionally linked and/or associated with processing center 104 shown as being above ground.

System 100 shows pool systems and/or machine rooms 12, comprising filter and pumps, that are fit with an optional sensor 106 that is functionally coupled with processing center 104. Preferably processing center 104 can apply adaptive filters to data received from sensor 106 so as to improve the signal to noise ratio received form array 102.

As shown, system 100 and in particular processing center 104 is further functionally associated with an auxiliary device 20 for receiving an alarm state signal 105 that may be communicated from processing center 104.

While FIG. 5 depicts implementation of system 100 with a built-in swimming pool 10, system 100 is not limited to such implementation and may be utilized in any body of water having a defined and/or definable monitoring area. Such a body of water may for example include but is not limited to at least one or more of an above ground swimming pool, a defined area within a lake, a defined area within a body of water, a defined area within an ocean, a defined area within a sea, a water reservoir, a water tank, an artificial lake, a canal, a bathtub, a Jacuzzi or the like.

FIG. 4 show a further depiction of system 100 showing processing module 110 in greater detail. As shown, acoustic signals from at least one of array 102 and/or sensor 106 are provided to and/or communicated to processing center 104.

In embodiments, the raw acoustic signals from array 102 are communicated to a beam forming phase control module 120 generating directional data set from the hydrophone data provided by array 102.

In embodiments module 120 is utilized to form a plurality of directional acoustic beams in a manner that will cover the area defined by the hydrophone array 102 and the volume of the body of water being monitored. Preferably such beam forming facilitates locating the drowning event relative to the location of the hydrophones.

In embodiments the phase control module 120 will apply variable phase control shifts to individual hydrophones (102n) of the hydrophone array 102 so as to form beams that will cover the entire monitored body of water.

Preferably the acoustic directional data set and the external sensor data 106 is communicated to signal processing module 110 to undertake and perform data filtering with an adaptive filter module 112, frame splitting with frame splitting module 114, and to perform frequency analysis with frequency analysis module 116. All provided to identify an acoustic signature signal that is associated with a drowning event. More preferably the acoustic signature has an identifiable frequency band from about 200 Hz and up to about 1200 Hz and optionally up to about 1500 Hz.

The processed data is then provided to decision logic module 122 and/or automated classifier provided that facilitate identifying and/or classifying the signal into a drowning signal or not. Preferably the decision module 122 is rendered with reference to a bank and/or library and/or database 118 comprising a plurality of pre-classified drowning signatures and/or drowning signal criteria. In some embodiments, module 122 may further be provided with artificial intelligence and learning capabilities and able to identify and learn drowning incident over time.

If module 122 positively identifies a drowning incident an alarm state protocol module 124 is implemented. Preferably module 124 generates alarm signal 105 and communicates it to the appropriate auxiliary devices 20, as previously described. More preferably module 124 further communicates the location of the drowning event relative to the location of the hydrophone nearest the drowning incident.

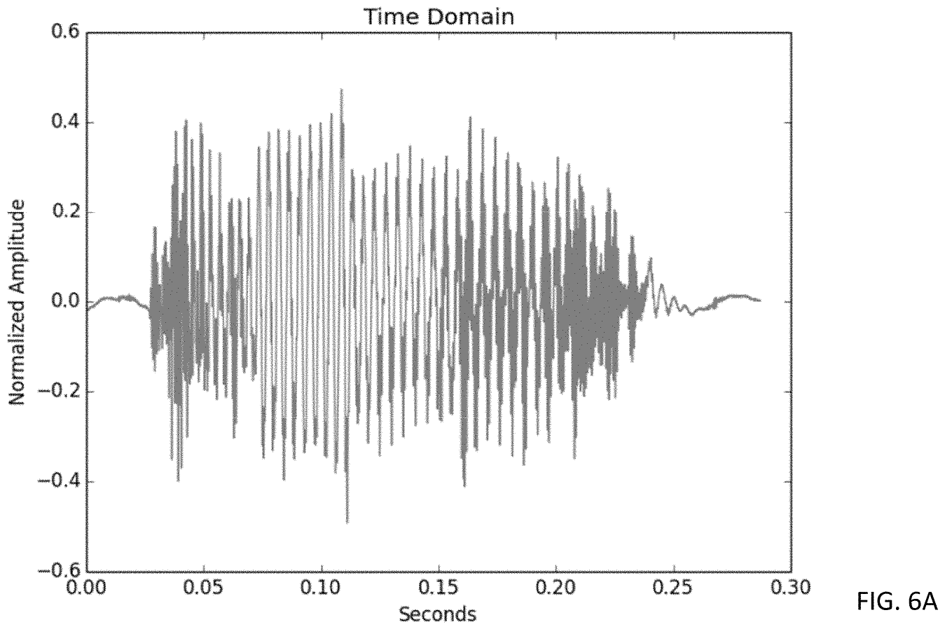

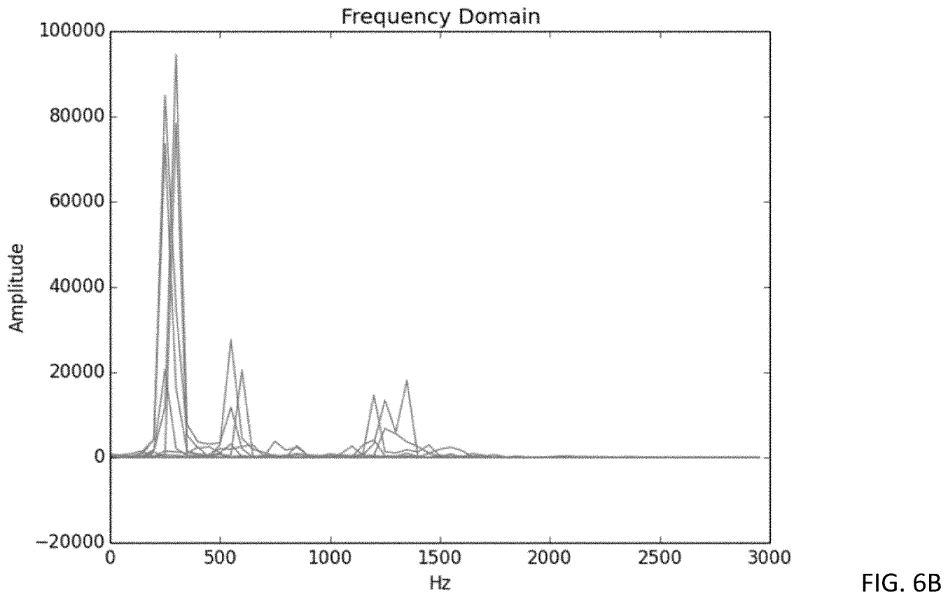

FIG. 6A shows an example of a time domain acoustic signal of a drowning incident as provided by a hydrophone array 102 of hydrophone module 101 prior to classification, however, following adaptive filtering. The signal shown in FIG. 6A does not implicitly show specific signals that are identifiable with a drowning incident, therefore a signature is not readily identifiable from the time domain signal.

FIG. 6B shows the signal depicted in FIG. 6A, following frequency domain processing where an acoustic signature associated with drowning is visible with frequency bands that are identifiable in the 200 Hz to 1500 Hz.

This acoustic signature is believed to be associated with acoustic waves generated by the body during a drowning event. The drowning sound may be explained on the basis of known anatomical defense reflexes that together are implemented to try to prevent entry of water or unwanted substance into the upper and lower respiratory system. These reflexes include a laryngospasm and a cough reflex that are known to be activated by irritant receptors that are located mainly on the wall of the trachea, pharynx, and carina, or by stimulation of the auricular branch (Arnold's reflex via internal laryngeal nerve). When both reflexes are triggered, axonal impulses of the vagus nerve begin a chain reaction that reaches the medulla, with efferent back in to respiratory system (glottis, vocal cords, diaphragm, intercostal muscles) is observed. A combination of these reflexes activates a blocking and/or repelling defensive actions to prevent water, or the like foreign object, from entering the respiratory system, and in turn gives rise to the unique drowning acoustic signature, monitored by embodiments of the present invention.

While the invention has been described with respect to a limited number of embodiment, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not described to limit the invention to the exact construction and operation shown and described and accordingly, all suitable modifications and equivalents may be resorted to, falling within the scope of the invention.

Having described a specific preferred embodiment of the invention with reference to the accompanying drawings, it will be appreciated that the present invention is not limited to that precise embodiment and that various changes and modifications can be effected therein by one of ordinary skill in the art without departing from the scope or spirit of the invention defined by the appended claims.

Further modifications of the invention will also occur to persons skilled in the art and all such are deemed to fall within the spirit and scope of the invention as defined by the appended claims.

While the invention has been described with respect to a limited number of embodiments, it will be appreciated that many variations, modifications and other applications of the invention may be made.

What is claimed is:

1) A system for monitoring a body of water for and alarm state and generating an alarm when such alarm sate is identified, the system comprising:
a) at least one hydrophone submerged in the body of water for receiving acoustic signals;
b) a processing center functionally associated with said at least one hydrophone, the processing center provided for performing signal processing analysis on said acoustic signals comprising:
i) filtering and boosting said acoustic signals;
ii) signal splitting into a plurality of overlapping windows having a predetermined length of time and a degree of overlap.
iii) performing at least one of a time-domain analysis or a frequency-domain analysis on said overlapping windows;
iv) comparing sequential windows relative to a predetermined threshold;
v) identifying a changes between sequential windows by comparing to said predetermined threshold;
vi) if a significant change is identified undertake classification of a series of sequential windows to determine if there was a breach of the water surface and to classify the type of breach that took place;
vii) if a breach is identified communicate an alarm signal;
c) an individualization module provided for individualizing said processing center (104) to said body of water, wherein said individualization module provides for configuring a plurality of processing parameters utilized by said processing center that are specific for said body of water; and wherein said plurality of processing parameters comprises at least two or more selected from: filtering coefficients, time-domain analysis coefficients, frequency-domain analysis coefficients, threshold levels, length of overlapping windows, degree of overlap of said overlapping windows; coefficients determining of auto-regression analysis model; coefficients of determining the Mel Frequency Cepstrum Model; or combination thereof; and
d) an alarm module for receiving and communicating said alarm signal.

2) The system of claim 1 further comprising an accelerometer that is functionally associated with said processing center and wherein said accelerometer is disposed relative to the pool water surface; and wherein data obtained from said accelerometer is processed with said processing center in parallel with said acoustic signal provided with said hydrophone.

3) The system of claim 1 wherein said time domain analysis is an auto regressive (AR) model analysis.

4) The system of claim 1 wherein said frequency domain analysis is a Mel Frequency Cepstrum Model (MFCM).

5) The system of any one of claim 1 wherein said processing center is configured to performs both time domain and frequency domain analysis.

6) The system of claim 1 further comprising a plurality of hydrophones.

7) The system of claim 6 wherein said plurality of hydrophones form a hydrophone array that is arranged along a surface defining said body of water.

8) The system of claim 7 wherein said processing center is functionally associated with said hydrophone array, the processing center having a signal processing module configured for analyzing signals obtained with the hydrophone array module to identify an acoustic signature indicative of an alarm event in the form of a drowning event, the acoustic signature having at least one frequency band peak of up to 1500 Hz characterized in that the acoustic signature is correlated to acoustic waves generated by a drowning individual during the drowning event.

9) The system of claim 7 wherein said hydrophone array is arranged along at least one of a lower surface or a side surface defining the body of water.

10) The system of claim 7 wherein said hydrophone array comprises a first hydrophone array arrangement disposed along a lower surface of the body of water and a second hydrophone array arrangement disposed along the height of the body of water along at least one or more side wall surface.

11) The system of claim 9 wherein said hydrophone array is embedded or integrated with at least one of a swimming pool floor or a side wall.

12) The system of claim 1 wherein said system is provided within a dedicated housing configured such that said housing is a floating housing wherein said hydrophone is submerged within said body of water.

13) The system of claim 1 further comprising a sensor module comprising at least one sensor selected from the group: Light Detection And Ranging (LIDAR), thermal imaging sensor.

14) The system of claim 1 wherein said processing center is further configured to identify the point of entry of the unauthorized entry.

15) The system of claim 1 further comprising an aqueous sensor module comprising at least one or more sensors submerged within the body of water.

16) The system of claim 1 further comprising at least one light source disposed adjacent to said at least one hydrophone and configured to be activated once an alarm state is identified.

17) The system of claim 1 further comprising an auxiliary device selected from: a horn, an alarm, a video surveillance system, a camera, an image capturing device, a pool system device, a communication device, a mobile communication device, a pool control system, pool valves, a water feature subsystem (waterfall), a pool lighting system, a pool sanitation system, a pool cleaning robot, a pool temperature control systems, a pool pump system, a pool sound system, a pool filtration system, a server, a first respondent call center, an emergency services call center, and any combination thereof.

18) A method for determining an alarm state with the system of claim 1, the method comprising:
a) Associating system 100 with a body of water that is to be monitored for unauthorized entry;
b) Undertake an individualization to determine the signal processing coefficients specific for the body of water;
c) Obtaining an acoustic signal with at least one hydrophone;
d) filtering and boosting said signal;
e) signal splitting into a plurality of overlapping windows having a predetermined length of time and a degree of overlap.
f) performing at least one of a time-domain analysis or a frequency-domain analysis on said overlapping windows;
g) comparing sequential windows relative to a predetermined threshold
h) identifying a change between sequential windows by comparing to said predetermined threshold;
i) if a significant change is identified undertake classification of a series of sequential windows to determine if there was a breach of the water surface and to classify the type of breach that took place;
j) if a breach is identified communicate an alarm signal to alarm module.

19) The method of claim 16 further comprising obtaining additional data with an accelerometer.

20) The method of claim 16 further comprising obtaining additional data with at least one sensor selected from: image sensor, camera, thermal imaging device, infrared (IR) sensor, LIDAR, and any combination thereof.
